(19) United States
(12) Patent Application Publication
(10) Pub. No.: US 2023/0367526 A1
(43) Pub. Date: Nov. 16, 2023

(54) COMPATIBLE METHOD AND APPARATUS FOR SELF-SERVICE PRINTING BACKGROUND, AND DEVICE, STORAGE MEDIUM AND SYSTEM

(71) Applicant: SHENZHEN SENSETIME TECHNOLOGY CO., LTD., Shenzhen (CN)

(72) Inventors: Ye WANG, Shenzhen (CN); Guoqing GUO, Shenzhen (CN); Junjie YAO, Shenzhen (CN); Bin SUN, Shenzhen (CN); Chang LIU, Shenzhen (CN); Jie DING, Shenzhen (CN); De XIE, Shenzhen (CN); Feng GAO, Shenzhen (CN); Xiucheng WANG, Shenzhen (CN)

(21) Appl. No.: 18/359,939

(22) Filed: Jul. 27, 2023

Related U.S. Application Data
(63) Continuation of application No. PCT/CN2021/103647, filed on Jun. 30, 2021.

(30) Foreign Application Priority Data
Feb. 5, 2021 (CN) 202110164906.7

(51) Int. Cl. G06F 3/12

(52) U.S. Cl. CPC G06F 3/1238; G06F 3/1222; G06F 3/1236; G06F 3/1205; G06V 40/172

(57) ABSTRACT

A compatible method for a self-service printing background includes: background configuration interface is presented in response to acquired background configuration event, herein background configuration interface is at least configured to configure interaction parameters between biometric feature recognition device and background of biometric feature recognition device and between biometric feature recognition device and printing device; user configuration event is received on background configuration interface; background configuration information of printing device and address of background of biometric feature recognition device are acquired based on user configuration event, herein background configuration information of printing device includes printing parameters of printing device and address of printing device; and configurations between biometric feature recognition device and background of the biometric feature recognition device and between biometric feature recognition device and printing device are performed based on background configuration information of printing device and address of background of biometric feature recognition device.

### CROSS-REFERENCE TO RELATED APPLICATIONS

This application is a continuation of International Application No. PCT/CN2021/103647, filed on Jun. 30, 2021, which claims priority to Chinese Patent Application No. 202110164906.7, filed on Feb. 5, 2021. The disclosures of International Application No. PCT/CN2021/103647 and Chinese Patent Application No. 202110164906.7 are hereby incorporated by reference in their entireties.

### BACKGROUND

At present, for office needs, many companies set up shared printing devices for employees to print files, that is, a plurality of employees use the same shared printing device to print the files at the same time. At present, a biometric feature-based printing mode is a newest popular mode that authenticates a biometric feature and performs the printing of a file after the biometric feature is authenticated successfully. In a biometric feature-based printing mode, a biometric feature recognition device needs to interact with a printing device. However, manufacturers of different printing devices have different printing parameters and transmission modes that need to be transmitted for the biometric feature recognition device. There will be a problem that different programs need to be developed for the biometric feature recognition device, so as to meet the requirements of the manufacturers of different printing devices for the printing parameters and the transmission modes. Therefore, the development cost is increased.

### SUMMARY

The present disclosure relates to electronic technologies, and relates, but is not limited, to a compatible method and apparatus for a self-service printing background, and a device, a storage medium and a system.

In view of this, the embodiments of the present disclosure provide a compatible method and apparatus for a self-service printing background, and a device, a storage medium and a system.

Technical solutions of the embodiments of the present disclosure are implemented as follows.

In a first aspect, the embodiments of the present disclosure provide a compatible method for a self-service printing background, which is applied to a biometric feature recognition device. The method may include: a background configuration interface is presented in response to an acquired background configuration event, herein the background configuration interface is at least configured to configure interaction parameters between the biometric feature recognition device and a background of the biometric feature recognition device and between the biometric feature recognition device and a printing device; a user configuration event is received on the background configuration interface; background configuration information of the printing device and an address of the background of the biometric feature recognition device are acquired based on the user configuration event, herein the background configuration information of the printing device includes printing parameters of the printing device and an address of the printing device; and configurations between the biometric feature recognition device and the background of the biometric feature recognition device and between the biometric feature recognition device and the printing device are performed based on the background configuration information of the printing device and the address of the background of the biometric feature recognition device. Thus, the requirements of backgrounds of different biometric feature recognition devices and different printing devices can be compatible by means of configuration, so as to reduce the development cost and improve the work efficiency.

In a second aspect, the embodiments of the present disclosure provide a compatible apparatus for a self-service printing background. The apparatus includes a memory storing processor-executable instructions, and a processor. The processor is configured to execute the stored processor-executable instructions to perform operations of: presenting a background configuration interface in response to an acquired background configuration event, wherein the background configuration interface is at least configured to configure interaction parameters between a biometric feature recognition device and a background of the biometric feature recognition device and between the biometric feature recognition device and a printing device; receiving a user configuration event on the background configuration interface; acquiring background configuration information of the printing device and an address of the background of the biometric feature recognition device based on the user configuration event, wherein the background configuration information of the printing device comprises printing parameters of the printing device and an address of the printing device; and performing configurations between the biometric feature recognition device and the background of the biometric feature recognition device and between the biometric feature recognition device and the printing device based on the background configuration information of the printing device and the address of the background of the biometric feature recognition device.

In a third aspect, the embodiments of the present disclosure provide a computer readable storage medium, which may have computer-executable instructions stored thereon. The computer-executable instructions are executed by a processor to implement operations of: presenting a background configuration interface in response to an acquired background configuration event, wherein the background configuration interface is at least configured to configure interaction parameters between a biometric feature recognition device and a background of the biometric feature recognition device and between the biometric feature recognition device and a printing device; receiving a user configuration event on the background configuration interface; acquiring background configuration information of the printing device and an address of the background of the biometric feature recognition device based on the user configuration event, wherein the background configuration information of the printing device comprises printing parameters of the printing device and an address of the printing device; and performing configurations between the biometric feature recognition device and the background of the biometric feature recognition device and between the biometric feature recognition device and the printing device based on the background configuration information of the printing device and the address of the background of the biometric feature recognition device.

### BRIEF DESCRIPTION OF THE DRAWINGS

FIG. 1 illustrates an implementation flowchart 1 of a compatible method for a self-service printing background of the embodiments of the present disclosure.

FIG. 2 illustrates an implementation flowchart 2 of the compatible method for the self-service printing background of the embodiments of the present disclosure.

FIG. 3 illustrates an implementation flowchart 3 of the compatible method for the self-service printing background of the embodiments of the present disclosure.

FIG. 4A illustrates a schematic diagram of a standby screen of a printing device of the embodiments of the present disclosure.

FIG. 4B illustrates a schematic diagram of a display interface of a printing application of the embodiments of the present disclosure.

FIG. 4C illustrates a schematic diagram of a display interface of a printing service configuration of the embodiments of the present disclosure.

FIG. 5A illustrates a structural schematic diagram of a printer bracket provided by the embodiments of the present disclosure.

FIG. 5B illustrates an implementation flowchart of a self-service printing method provided by the embodiments of the present disclosure.

FIG. 5C illustrates a schematic diagram of a connection between a biometric feature recognition device and the printing device of the embodiments of the present disclosure.

FIG. 5D illustrates a schematic structural diagram of compositions of a compatible system for the self-service printing background of the embodiments of the present disclosure.

FIG. 6 illustrates a schematic structural diagram of compositions of a compatible apparatus for the self-service printing background of the embodiments of the present disclosure.

FIG. 7 illustrates a schematic diagram of a hardware entity of the biometric feature recognition device of the embodiments of the present disclosure.

### DETAILED DESCRIPTION

The technical solutions of the present disclosure will further be elaborated below in combination with the drawings and the embodiments. It is apparent that the described embodiments are not all but only part of embodiments of the present disclosure. All other embodiments obtained by those of ordinary skill in the art based on the embodiments of the present disclosure without creative work shall fall within the scope of protection of the present disclosure.

“Some embodiments” involved in the following descriptions describes a subset of all possible embodiments. However, it can be understood that “some embodiments” may be the same subset or different subsets of all the possible embodiments, and may be combined without conflicts.

In the following descriptions, suffixes for representing elements, like “module”, “part” or “unit”, are used only for the ease of describing the present disclosure, and they have no specific meanings. Therefore, “module”, “part” or “unit” may be combined for use.

It is to be pointed out that term “first/second/third” involved in the embodiments of the present disclosure is only for distinguishing similar objects and does not represent a specific sequence of the objects. It can be understood that “first/second/third” may be interchanged to specific sequences or orders if allowed to implement the embodiments of the present disclosure described herein in sequences except the illustrated or described ones.

A face recognition printing mode is a newest popular mode that performs the printing of a file through face recognition at present. A biometric feature-based printing mode is described below by taking a face recognition printing mode as an example of the biometric feature-based printing mode.

It can be understood that a face recognition device (also called a face swiping device) needs to collect a face image of a target user (a user who needs to print a file), and then the face recognition device or a background server of the face recognition device (a background of the face recognition device) performs face authentication. After a face is authenticated successfully, a target user account bound to the collected face is sent to a printing device for the printing device to perform a printing operation of the file.

It is to be noted that face authentication may generally be implemented in two modes: the first is that the face authentication is performed locally at the face recognition device, and the second is that the face authentication is performed at the background of the face recognition device. The first mode is suitable for a case where the number of user groups is relatively small, for example, several to hundreds of users. The second mode is suitable for a case where the number of user groups is relatively large, for example, thousands or even tens of thousands of users.

In a case where the face authentication is performed locally at the face recognition device, the face recognition device compares the collected face image with a locally pre-stored face image. In a case where the comparison results in a successful match, a target user account matching the collected face image is determined. Thus, the face authentication is performed locally at the face recognition device.

In a case where the face authentication is performed at the background of the face recognition device, the face recognition device may send the collected face image to the background of the face recognition device. The background of the face recognition device compares the collected face image with the pre-stored face image. In a case where the comparison results in a successful match, a target user account matching the collected face image is determined, and is returned to the face recognition device. Thus, the face authentication is performed at the background of the face recognition device.

There may be the following three solutions for the face recognition device to interact with the printing device or the background of the printing device to perform printing.

In an embodiment of a first printing implementation mode, the face recognition device may interact with the printing device, that is, the face recognition device sends the target user account to the printing device. The printing device queries, according to the target user account, a stored mapping relationship to obtain an identifier of a file to be printed belonging to a target user, acquires the file to be printed according to the identifier of the file to be printed, and then prints the file to be printed.

In an embodiment of a second printing implementation mode, the face recognition device may interact with the background of the printing device, that is, the face recognition device sends the target user account to the background of the printing device. The background of the printing device queries, according to the target user account, a stored mapping relationship to obtain an identifier of a file to be printed belonging to a target user, and sends the identifier of the file to be printed to the printing device. The printing device acquires the file to be printed from the local according to the identifier of the file to be printed, and then prints the file to be printed.

In an embodiment of a third printing implementation mode, the face recognition device may interact with the background of the printing device, that is, the face recognition device sends the target user account to the background of the printing device. The background of the printing device queries, according to the target user account, a stored mapping relationship to obtain an identifier of a file to be printed belonging to the target user, acquires the file to be printed according to the identifier of the file to be printed, and then sends the file to be printed to the printing device. Finally, the printing device prints the file to be printed.

It can be seen from the above three modes of implementing printing that in the first printing implementation mode, the background of the printing device is not set, the face recognition device interacts with the printing device without the participation of the background of the printing device, and the printing device stores the mapping relationship and the file to be printed. The similarity between the second and third printing implementation modes is that the background of the printing device needs to participate in a process of printing the file, and the background of the printing device stores the mapping relationship. The difference between the second and third printing implementation modes is that in the second printing implementation mode, the printing device pre-stores the file to be printed (the file to be printed may be sent to the printing device for storage in advance by the background of the printing device, or may also be directly sent to the printing device by the face recognition device). Therefore, the background of the printing device only needs to send the identifier of the file to be printed to the printing device. In the third printing implementation mode, the printing device does not store the file to be printed in advance, and the background of the printing device needs to send to the file to be printed to the printing device. The first and second printing implementation modes have high requirement for a storage medium of the printing device since the printing device needs to store files to be printed, which is suitable for the case where the number of user groups is relatively small; and the third mode is suitable for the case where the number of user groups is large since the printing device does not need to store files in advance.

The face recognition device is an electronic device with an image collection function. In an implementing process, the face recognition device may be a portable terminal for face recognition, such as a pass machine. Of course, the devices with a face recognition function, such as a mobile phone, a tablet computer and a hand-held device, can also be used.

Face information may be regarded as a biometric feature. The biometric feature may also include fingerprint information, voiceprint information, iris information, finger vein information, etc. In other words, a face recognition-based printing mode can be understood as a biometric feature-based printing mode. On this basis, the face recognition device may be understood as an electronic device for performing biometric feature recognition (called a biometric feature recognition device for short). The biometric feature recognition device may include a face recognition device, a fingerprint recognition device, a voiceprint recognition device, an iris recognition device, a finger vein recognition device, etc. Considering the factors such as easiness in installation, the biometric feature recognition device generally adopts a portable mobile electronic device.

On this basis, the embodiments of the present disclosure provide a compatible method for a self-service printing background, which is applied to a biometric feature recognition device. The functions realized by the method may be realized by calling program codes by a processor in the biometric feature recognition device. Of course, the program codes may be stored in a computer storage medium of the biometric feature recognition device.

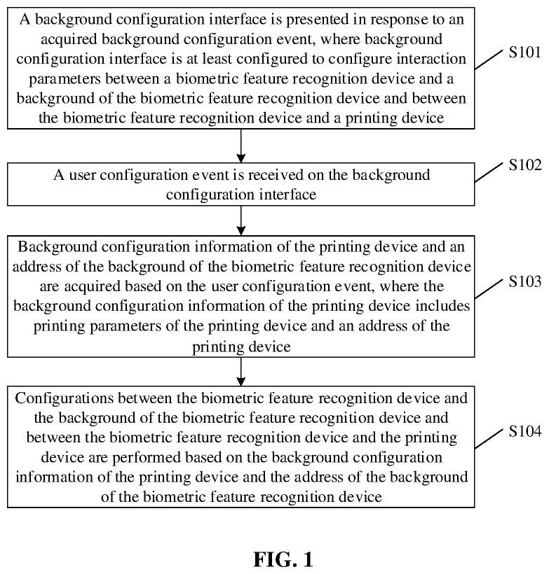

FIG. 1 illustrates an implementation flowchart 1 of a compatible method for a self-service printing background of the embodiments of the present disclosure. As shown in FIG. 1, the method includes the following operations.

At S101, a background configuration interface is presented in response to an acquired background configuration event. The background configuration interface is at least configured to configure interaction parameters between a biometric feature recognition device and a background of the biometric feature recognition device and between the biometric feature recognition device and a printing device.

Here, the biometric feature recognition device may be various types of devices with information processing capacity and biometric feature recognition capacity, such as a mobile phone, a Personal Digital Assistant (PDA), a smart watch, a smart bracelet, a wearable device, a tablet computer, and an all-in-one machine. The biometric feature recognition device may include a face recognition device, a fingerprint recognition device, a voiceprint recognition device, an iris recognition device, a finger vein recognition device, etc.

Here, the background configuration event may be automatic detection of whether configuration is performed. If the configuration is not performed, then the configuration is performed as soon as the biometric feature recognition device is powered on. The background configuration event may also be that a user uses some assemblies to trigger background configuration, for example, to modify previous configuration.

In the embodiments of the present disclosure, after the biometric feature recognition device acquires the background configuration event, the background configuration interface needs to be displayed, so that a target user (a user with a printing demand) may configure the interaction parameters between the biometric feature recognition device and the background of the biometric feature recognition device and the interaction parameters between the biometric feature recognition device and the printing device based on the background configuration interface.

At S102, a user configuration event is received on the background configuration interface.

Here, the user configuration event is generally triggered by installation personnel or manufacturer service personnel. User configuration parameters corresponding to the user configuration event may include selection items of a user, input items of the user, etc. The user configuration parameters may be some parameters manually input by the user, for example, a model of the printing device. The user configuration parameters may also be some parameters automatically generated according to the input of the user, for example, the model of the printing device input by the user, and then a parameter transmission mode of the printing device can be automatically selected. The user configuration parameters may also be some parameters automatically generated according to time, for example, a timestamp, a signature, etc. may be generated according to a user identifier and a current time after the user identifier (e.g., an Identity Card (IC) Number of the user) is determined. That is to say, those skilled in the art can set the types of the user configuration parameters according to actual use requirements. The embodiments of the present disclosure do not limit the content of the actual user configuration parameters.

At S103, background configuration information of the printing device and an address of the background of the biometric feature recognition device are acquired based on the user configuration event, herein the background configuration information of the printing device includes printing parameters of the printing device and an address of the printing device.

In the embodiments of the present disclosure, the biometric feature recognition device may acquire the background configuration information of the printing device based on the user configuration event. For example, the background configuration information includes some printing parameters (a data transmission mode, a user identifier, a timestamp, a signature, etc.) and the address of the printing device. The biometric feature recognition device may also acquire the address of the background of the biometric feature recognition device based on the user configuration event.

At S104, configurations between the biometric feature recognition device and the background of the biometric feature recognition device and between the biometric feature recognition device and the printing device are performed based on the background configuration information of the printing device and the address of the background of the biometric feature recognition device.

Here, the biometric feature recognition device may perform the configuration between the biometric feature recognition device and the printing device according to the printing parameters of the printing device and the address of the printing device. The biometric feature recognition device may also perform the configuration between the biometric feature recognition device and the background of the biometric feature recognition device according to the address of the background of the biometric feature recognition device.

Thus, if the biometric feature recognition device needs to connect different printing devices, then only the printing parameters corresponding to the printing devices and the addresses corresponding to the printing devices need to be configured on the background configuration interface to adapt to different printing devices. If the biometric feature recognition device needs to connect different backgrounds (for example, SenseLink or SenseOffice), then only the addresses corresponding to the backgrounds need to be configured on the background configuration interface to adapt to different backgrounds. SenseLink is an intelligent Internet of Things (IOT) platform, which mainly provides device access and basic scenario services for an intelligent terminal product. SenseOffice is a smart office platform system, which can provide the functions of space management, attendance management, an intelligent conference room, intelligent printing, Artificial Intelligence (AI), temperature measurement, etc.

In some embodiments, the method further includes the following operations.

The step that the background configuration event is acquired includes at least one of the following operations.

At S11a, an invalid address of the printing device is detected.

For example, after a user clicks on print, the biometric feature recognition device detects the invalid address of the printing device, and then a background configuration interface can pop up automatically.

At S12a, an invalid address of the background of the biometric feature recognition device is detected.

For example, after a user clicks on print, the biometric feature recognition device detects the invalid address of the background of the biometric feature recognition device, and then a background configuration interface can pop up automatically.

At S13a, a key instruction satisfying a preset condition is detected.

For example, if a biometric feature recognition device is in a shutdown state, after a user clicks a power button to start up, the biometric feature recognition device can automatically pop up a background configuration interface to make the user confirm whether configuration needs to be performed. For another example, if a user changes a printing device after using for a period of time, then a certain key operation or key combination operation may be performed after the printing device is replaced, and a background configuration interface pops up in response to this operation.

In the embodiments of the present disclosure, the background configuration interface is presented in response to the acquired background configuration event, herein the background configuration interface is at least configured to configure interaction parameters between the biometric feature recognition device and the background of the biometric feature recognition device and between the biometric feature recognition device and the printing device; the user configuration event is received on the background configuration interface; the background configuration information of the printing device and the address of the background of the biometric feature recognition device are acquired based on the user configuration event, herein the background configuration information of the printing device includes the printing parameters of the printing device and the address of the printing device; and the configurations between the biometric feature recognition device and the background of the biometric feature recognition device and between the biometric feature recognition device and the printing device are performed based on the background configuration information of the printing device and the address of the background of the biometric feature recognition device. Thus, the requirements of the backgrounds of different biometric feature recognition devices and different printing devices can be compatible by means of configuration, so as to reduce the development cost and improve the work efficiency.

Based on the previously described embodiments, the embodiments of the present disclosure further provide a compatible method for a self-service printing background. The method is applied to a biometric feature recognition device. The method includes the following operations.

At S111, a background configuration interface is presented in response to an acquired background configuration event, herein the background configuration interface is at least configured to configure interaction parameters between a biometric feature recognition device and a background of the biometric feature recognition device and between the biometric feature recognition device and a printing device.

At S112, a user configuration event is received on the background configuration interface.

At S113, user configuration parameters corresponding to the user configuration event are acquired based on the user configuration event, herein the user configuration parameters include an identifier of the background of the biometric feature recognition device.

At S114, one or more addresses matching an address of the background of the biometric feature recognition device are determined from an address list based on the identifier of the background of the biometric feature recognition device.

At S115, the address of the background of the biometric feature recognition device is presented, so that a user modifies or confirms the address of the background of the biometric feature recognition device.

Here, the user configuration parameters include the identifier of the background of the biometric feature recognition device, and then the address of the background corresponding to the identifier may be determined from a plurality of address lists based on the identifier of the background of the biometric feature recognition device (such as an identifier of SenseLink, or an identifier of SenseOffice). The matching address is presented to the user. Thus, the user can directly confirm whether the address is correct. If the address is incorrect, the address can be manually modified, which prevents the user from manually inputting the address directly, improves the user experience, and reduces the filling error rate.

At S116, background configuration information of the printing device is acquired based on the user configuration event, herein the background configuration information of the printing device includes printing parameters of the printing device and an address of the printing device.

At S117, configurations between the biometric feature recognition device and the background of the biometric feature recognition device and between the biometric feature recognition device and the printing device are performed based on the background configuration information of the printing device and the address of the background of the biometric feature recognition device.

In some embodiments, the identifier of the background of the biometric feature recognition device includes a type of the background of the biometric feature recognition device and a user keyword.

For example, the user can input a keyword SenseLink or SenseOffice to match a corresponding background address.

Correspondingly, S114 that one or more addresses matching an address of the background of the biometric feature recognition device are determined from an address list based on the identifier of the background of the biometric feature recognition device may be implemented in the following modes.

At S1141, at least one candidate background address is determined based on the type of the background of the biometric feature recognition device and the user keyword.

Here, the type of the background of the biometric feature recognition device and the user keyword may correspond to a unique address or may correspond to a plurality of addresses. If a unique matching address is determined, then the address is taken as the address of the background of the biometric feature recognition device. If more than one matching address is determined, then the address may be displayed in the form of list or card for a user to select.

At S1142, in response to a case where the at least one candidate background address is one address, the only one address is determined as the address of the background of the biometric feature recognition device.

At S1143, in response to a case where the at least one candidate background address is more than two addresses, the more than two addresses are presented in the form of list.

At S1144, the address of the background of the biometric feature recognition device is acquired in response to a triggering event on a selection list.

Herein, by the operations of S1141 to S1144, a matching addresses satisfying a condition can be determined for the user to select according to the type of the background of the biometric feature recognition device and the user keyword input by the user, so that the operation of configuring the address of the background of the biometric feature recognition device becomes simple and clear.

Based on the previously described embodiments, the embodiments of the present disclosure further provide a compatible method for a self-service printing background. The method is applied to a biometric feature recognition device. The method includes the following operations.

At S121, a background configuration interface is presented in response to an acquired background configuration event, herein the background configuration interface is at least configured to configure interaction parameters between the biometric feature recognition device and the background of the biometric feature recognition device and between the biometric feature recognition device and the printing device.

At S122, a user configuration event is received on the background configuration interface.

At S123, user configuration parameters corresponding to the user configuration event are acquired based on the user configuration event, herein the user configuration parameters include a model of the printing device.

At S124, a configuration template matching a target configuration template is determined from a preset template library based on the model of the printing device, herein the target configuration template includes printing parameters of the printing device enumerated by way of example, format requirements of the printing parameters, and modes of viewing the printing parameters.

At S125, after the target configuration template is presented, background configuration information of the printing device is acquired based on the input event of a user, herein the background configuration information of the printing device includes printing parameters of the printing device and an address of the printing device.

Here, the user configuration parameters include the type of the printing device, then the configuration template matching the target configuration template may be determined from the preset template library based on the model and the target configuration template is displayed to the user. Thus, the user can fill the background configuration information of the printing device in the background configuration interface with reference to the target configuration template, thereby achieving an intelligent filling effect, improving the user experience, and reducing the filling error rate. The target configuration template may include the contents such as printing parameters of the printing device enumerated by way of example, format requirements of the printing parameters, modes of viewing the printing parameters.

At S126, the address of the background of the biometric feature recognition device is acquired based on the user configuration event.

At S127, configurations between the biometric feature recognition device and the background of the biometric feature recognition device and between the biometric feature recognition device and the printing device are performed based on the background configuration information of the printing device and the address of the background of the biometric feature recognition device.

In some embodiments, the printing parameters include mandatory option parameters and default configuration item parameters. Correspondingly, after S125 that after the target configuration template is presented, the background configuration information of the printing device is acquired based on the input event of the user, the method further includes the following operations.

At S11b, the default configuration item parameters are determined based on the model of the printing device.

At S12b, the default configuration item parameters are filled into the target configuration template. The target configuration template includes mandatory option parameters enumerated by way of example, format requirements of the mandatory option parameters, and modes of viewing the mandatory option parameters.

Here, if the model of the printing device input by the user is acquired, some default configuration item parameters of the printing device corresponding to the model may be associated according to the model. Thus, these default configuration item parameters can be presented to a user, so as to facilitate the reference of the user. The mandatory option parameters may include a user account, etc.

In some embodiments, the default configuration item parameters at least include one of the following: a transmission protocol, a timestamp, a signature, and a credential. The mandatory option parameters include a user identifier.

Here, the transmission protocol is a mode in which the biometric feature recognition device transmits configuration parameters to the printing device. The timestamp is the data generated by using a digital signature technology. An object of the signature includes the information such as original file information, signature parameters, and signature time. A timestamp system is configured to generate and manage the timestamp, and digitally sign the object of the signature to generate the timestamp to prove that an original file has already existed before the signature time. The credential is assigned to different biometric feature recognition devices by the printing device. The printing device may execute a corresponding printing task according to the user identifier.

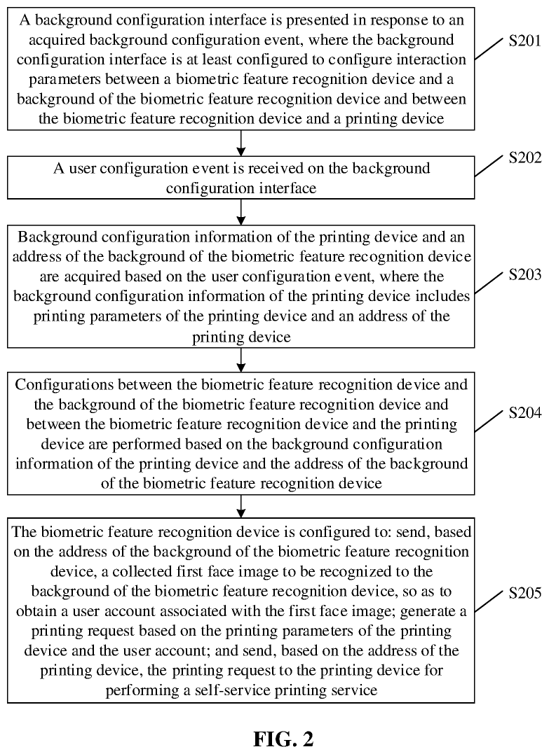

Based on the previously described embodiments, the embodiments of the present disclosure further provide a compatible method for a self-service printing background. The method is applied to a biometric feature recognition device. FIG. 2 illustrates an implementation flowchart 2 of the compatible method for the self-service printing background of the embodiments of the present disclosure. As shown in FIG. 2, the method includes the following operations.

At S201, a background configuration interface is presented in response to an acquired background configuration event, herein the background configuration interface is at least configured to configure interaction parameters between a biometric feature recognition device and a background of the biometric feature recognition device and between the biometric feature recognition device and a printing device.

At S202, a user configuration event is received on the background configuration interface.

At S203, background configuration information of the printing device and an address of the background of the biometric feature recognition device are acquired based on the user configuration event, herein the background configuration information of the printing device includes printing parameters of the printing device and an address of the printing device.

At S204, configurations between the biometric feature recognition device and the background of the biometric feature recognition device and between the biometric feature recognition device and the printing device are performed based on the background configuration information of the printing device and the address of the background of the biometric feature recognition device.

At S205, the biometric feature recognition device is configured to: send, based on the address of the background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

In the embodiments of the present disclosure, the biometric feature recognition device can only perform the configurations between the biometric feature recognition device and the background of the biometric feature recognition device and between the biometric feature recognition device and the printing device, but also send the user account corresponding to the collected image to be recognized to the printing device. Thus, the printing device can print the file corresponding to the user account in a case where a biometric feature is recognized successfully and the configuration of the contents on the background configuration interface is completed.

In some embodiments, the background configuration interface is further configured to configure interaction parameters between the biometric feature recognition device and a background for user account authentication. The background configuration information further includes an address of the background for user account authentication. The biometric feature recognition device is configured to send, based on the address of the background for user account authentication, the collected user account to the background for user account authentication, so as to obtain an account authentication result. The biometric feature recognition device is further configured to: in response to a case where the account authentication result is that the authentication is successful, associate a second face image to be entered with the user account to obtain an association relationship, and send the association relationship to the background of the biometric feature recognition device for storing; or, the biometric feature recognition device is further configured to: in response to a case where the account authentication result is that the authentication is successful, send the second face image to be entered and the user account to the background of the biometric feature recognition device for associating the second face image with the user account to obtain the association relationship.

Here, the biometric feature recognition device is further configured to acquire the address of the background for user account authentication based on the user configuration event. Thus, the biometric feature recognition device may interact with the account authentication background, so as to enter an unknown face in a case where the user account is authenticated successfully, thereby providing authentication materials for subsequent face recognition printing. For example, a new employee of the company can enter a face feature thereof on the biometric feature recognition device by using a job number assigned immediately upon entry, so that when the employee can pass the authentication of a face recognition printing system and perform a printing task when a file needs to be printed subsequently.

In the embodiments of the present disclosure, the background configuration interface is presented in response to the acquired background configuration event, herein the background configuration interface is at least configured to configure interaction parameters between the biometric feature recognition device and the background of the biometric feature recognition device and between the biometric feature recognition device and the printing device. The user configuration event is received on the background configuration interface. The background configuration information of the printing device and the address of the background of the biometric feature recognition device are acquired based on the user configuration event, herein the background configuration information of the printing device includes the printing parameters of the printing device and the address of the printing device. The configurations between the biometric feature recognition device and the background of the biometric feature recognition device and between the biometric feature recognition device and the printing device are performed based on the background configuration information of the printing device and the address of the background of the biometric feature recognition device. The biometric feature recognition device is configured to: send the collected first face image to be recognized to the background of the biometric feature recognition device based on the address of the background of the biometric feature recognition device, so as to obtain a user account associated with the first face image; generate the printing request based on the printing parameters of the printing device and the user account; and send, based on the address of the printing device, the printing request to the printing device for performing a self-service printing service. Thus, the requirements of the backgrounds of different biometric feature recognition devices and different printing devices can be compatible by means of configuration, so that the printing device can perform the printing task according to the user account and the printing parameters provided by the biometric feature recognition device, thereby achieving the purposes of reducing the development cost and improving the work efficiency.

Based on the previously described embodiments, the embodiments of the present disclosure further provide a compatible method for a self-service printing background. The method is applied to a biometric feature recognition device. The method includes the following operations.

At S211, a background configuration interface is presented in response to an acquired background configuration event, herein the background configuration interface is at least configured to configure interaction parameters between a biometric feature recognition device and a background of the biometric feature recognition device and between the biometric feature recognition device and a printing device.

At S212, a user configuration event is received on the background configuration interface.

At S213, user configuration parameters corresponding to the user configuration event are acquired based on the user configuration event, herein the user configuration parameters include an identifier of the background of the biometric feature recognition device and a model of the printing device.

At S214, one or more addresses matching an address of the background of the biometric feature recognition device are determined from an address list based on the identifier of the background of the biometric feature recognition device.

At S215, an address of the background of the biometric feature recognition device is presented, so that a user modifies or confirms the address of the background of the biometric feature recognition device.

At S216, a configuration template matching a target configuration template is determined from a preset template library based on the model of the printing device, herein the target configuration template includes printing parameters of the printing device enumerated by way of example, format requirements of the printing parameters, and modes of viewing the printing parameters.

At S217, after the target configuration template is presented, background configuration information of the printing device is acquired based on an input event of a user, herein the background configuration information of the printing device includes the printing parameters of the printing device and an address of the printing device.

At S218, configurations between the biometric feature recognition device and the background of the biometric feature recognition device and between the biometric feature recognition device and the printing device are performed based on the background configuration information of the printing device and the address of the background of the biometric feature recognition device.

At S219, the biometric feature recognition device is configured to: send, based on the address of the background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

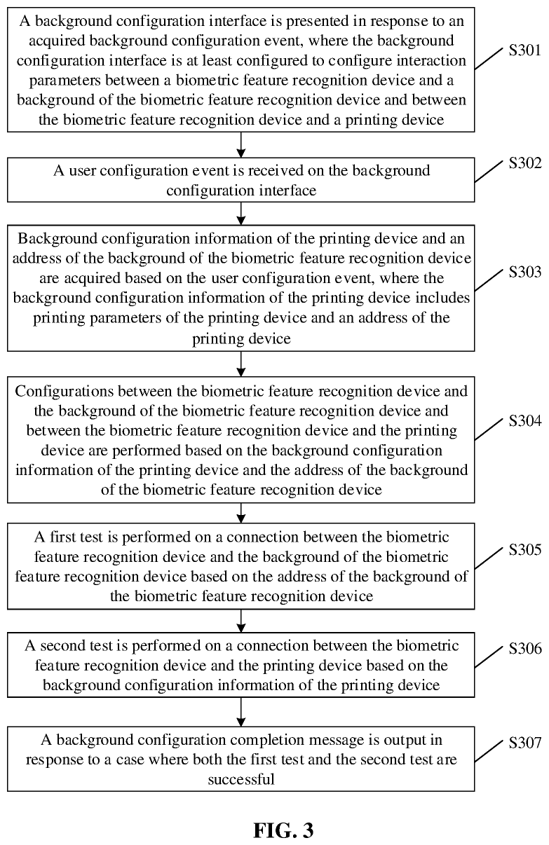

Based on the previously described embodiments, the embodiments of the present disclosure further provide a compatible method for a self-service printing background. The method is applied to a biometric feature recognition device. FIG. 3 illustrates an implementation flowchart 3 of the compatible method for the self-service printing background of the embodiments of the present disclosure. As shown in FIG. 3, the method includes the following operations.

At S301, a background configuration interface is presented in response to an acquired background configuration event, herein the background configuration interface is at least configured to configure interaction parameters between a biometric feature recognition device and a background of the biometric feature recognition device and between the biometric feature recognition device and a printing device.

At S302, a user configuration event is received on the background configuration interface.

At S303, background configuration information of the printing device and an address of the background of the biometric feature recognition device are acquired based on the user configuration event, herein the background configuration information of the printing device includes printing parameters of the printing device and an address of the printing device.

At S304, configurations between the biometric feature recognition device and the background of the biometric feature recognition device and between the biometric feature recognition device and the printing device are performed based on the background configuration information of the printing device and the address of the background of the biometric feature recognition device.

At S305, a first test is performed on a connection between the biometric feature recognition device and the background of the biometric feature recognition device based on the address of the background of the biometric feature recognition device.

Here, if the biometric feature recognition device has performed the configurations between the biometric feature recognition device and the background of the biometric feature recognition device and between the biometric feature recognition device and the printing device, then the biometric feature recognition device further needs to perform a test on the configuration between the biometric feature recognition device and the background of the biometric feature recognition device to test whether the configuration is correct, so as to prevent a failure in a subsequent printing process. The connection between the biometric feature recognition device and the background of the biometric feature recognition device is normal only in a case where the configuration is successful.

At S306, a second test is performed on a connection between the biometric feature recognition device and the printing device based on the background configuration information of the printing device.

Here, if the biometric feature recognition device has performed the configurations between the biometric feature recognition device and the background of the biometric feature recognition device and between the biometric feature recognition device and the printing device, then the biometric feature recognition device further needs to perform a test on the configuration between the biometric feature recognition device and the printing device to test whether the configuration is correct, so as to prevent a failure in a subsequent printing process. The connection between the biometric feature recognition device and the printing device is normal only in a case where the configuration is successful.

At S307, a background configuration completion message is output in response to a case where both the first test and the second test are successful.

Here, if both the first test and the second test are successful, then the background configuration completion message is output, and the configuration completion message may be sent to the printing device.

In some embodiments, S303 that an address of the background of the biometric feature recognition device is acquired based on the user configuration event may be implemented in the following modes: user configuration parameters corresponding to the user configuration event are acquired based on the user configuration event, herein the user configuration parameters include an identifier of the background of the biometric feature recognition device; and the one or more addresses matching the address of the background of the biometric feature recognition device are determined from an address list based on the identifier of the background of the biometric feature recognition device.

Correspondingly, the method further includes: the address of the background of the biometric feature recognition device is presented, so that a user modifies or confirms the address of the background of the biometric feature recognition device.

Here, the biometric feature recognition device can not only perform the configurations between the biometric feature recognition device and the background of the biometric feature recognition device and between the biometric feature recognition device and the printing device, but also present the matching background address to the user according to the acquired identifier of the background of the biometric feature recognition device. Thus, the user can configure the address of the biometric feature recognition device, so as to achieve a purpose of intelligent filling.

In some embodiments, S303 that the background configuration information of the printing device is acquired based on the user configuration event includes the following operations.

At S3031, user configuration parameters corresponding to the user configuration event are acquired based on the user configuration event, herein the user configuration parameters include a model of the printing device.

At S3032, a configuration template matching a target configuration template is determined from a preset template library based on the model of the printing device, herein the target configuration template includes printing parameters of the printing device enumerated by way of example, format requirements of the printing parameters, and modes of viewing the printing parameters.

At S3033, after the target configuration template is presented, background configuration information of the printing device is acquired based on an input event of a user.

In the embodiments of the present disclosure, the first test is performed on the connection between the biometric feature recognition device and the background of the biometric feature recognition device based on the address of the background of the biometric feature recognition device; the second test is performed on the connection between the biometric feature recognition device and the printing device based on the background configuration information of the printing device; and a background configuration completion message is output in response to the success of both the first test and the second test. Thus, the configured contents can be tested based on being compatible with the requirements of the backgrounds of different biometric feature recognition devices and different printing devices by means of configuration, thereby achieving the purposes of reducing the development cost, improving the work efficiency, and reducing printing failures.

At present, for office needs, many companies set up shared printing devices for employees to print files. That is, a plurality of employees use the same shared printing device to print the files at the same time. Meanwhile, with the development of a bionic technology and a pattern recognition technology, biometric features of human beings are used as the basis of individual identity identification in more and more fields, and face recognition is also widely used in various application occasions. Therefore, a printing system combining a biometric feature recognition device and a printing device is more and more used by major companies. The printing device can print a corresponding file according to a recognition result of the biometric feature recognition device, so as to perform a printing task accurately and quickly.

However, manufacturers of different printing devices have different printing parameters and transmission modes that need to be transmitted for the biometric feature recognition devices. At present, face recognition printing solutions on the market cannot be well compatible with the requirements of the backgrounds of all printing manufacturers for parameters. In addition to the manufacturers serving currently, a program may need to be modified when other manufacturers need to be served. Therefore, the development is increased.

Based on the previously described embodiments, the embodiments of the present disclosure provide a compatible solution for a self-service printing background. The solution only needs to modify the configuration in a face recognition device to be in compatible with the requirements of the backgrounds of all printing manufacturers for parameters by means of configuration, and the program does not need to be modified according to the requirements of higher-level backgrounds of different manufacturers, so that the configuration efficiency is improved.

That is to say, in the embodiments of the present disclosure, configurations are set in the face recognition device to be compatible with the requirements of the backgrounds of all printing manufacturers, so as to adapt to the printing services of different manufacturers. Meanwhile, a plurality of face recognition backgrounds may also be compatible by setting the configurations.

In some embodiments, the configurations may be modified on a local management interface of the face recognition device, or may also be issued by the background of the face recognition device.

Generally, a user identifier (e.g., an IC Number) will be obtained by face recognition during face recognition printing. The face recognition device transmits a user identity to a background for performing user recognition through a face recognition step. The user identity data required to be transmitted by the backgrounds of the manufacturers of different printing devices are different. In addition to the common IC Number identifying the user identity, a timestamp, a signature, and a credential assigned by a printing manufacturer to each face recognition device may also need to be transmitted. In addition, the modes required for transmitting are also different. Some printing manufacturers require a Hypertext Transfer Protocol (HTTP) mode, and some printing manufacturers require a Hypertext Transfer Protocol over Secure Socket Layer (HTTPS) mode. Some printing manufacturers are required to transmit in a Header, and some printing manufacturers are required to transmit in a Body. The Header is a word string sent before a server transmits Hyper Text Markup Language (HTML) data to a browser by the HTTP, and the Body is an HTML tag used in a web page, which represents a main body part of the HTML web page.

Therefore, different requirements need to be recognized to serve different printing manufacturers (that is, the printing devices of different manufacturers, and even the printing devices of different models of the same manufacturer). By the solution, the requirements of all printing manufacturer backgrounds for the parameters can be compatible by directly modifying the configuration. This configuration may be modified in a local management interface of the face recognition device, or may be issued by the background of the face recognition device.

An example of a typical configuration is as follows.

```
{“vendor”:“FujiXerox”,
“header”:{
  “sdkTimestamp”:“_ALIAS”,
  “sdkSignature”:“”,
  “solutionKey”:“6akc56p4riwfvykp303c”
  },
“param”:{
  “userName”:“TEST1”,
  “readerName”:“TC101085584967”
  },
“alias”:{“sdkTimestamp”:“timeStamp”},
“url”:“https://cloud.brocadesoft.com/sdkagent/open/mfp/login”,
“standby”:“”
}
```

Here, part parameters are described: “vendor” represents a manufacturer of a printing device, which is used for the face recognition device to distinguish different printing manufacturers. “sdkTimestamp” is a timestamp, and “_ALIAS” is a value of the timesample, which means alias and represents that other printing manufacturers are also required to transmit the parameter. “sdkSignature” is a signature. “url” is an address of a background of the printing device. “standby” is a standby screen.

It can be seen that the abovementioned configuration mainly includes three types of parameters, one is a parameter with a static value, one is a parameter with a null value, and one is a parameter with a value of ALIAS. The parameter with the static value represents that the value of the parameter is fixed and will not change when the manufacturer model of the printing device is known, for example, the address of the background of the printing device. The parameter with a null value represents that the value of the parameter changes at any time and cannot be predicted in advance, for example, a timestamp. The parameter with a value of ALIAS represents an existing field, which has a different parameter name, but the same parameter meaning (because different printing manufacturers also need the same parameter, but the parameter names that need to be returned are different).

It is to be noted that the above is only an example of the configuration. In an actual use process, the configuration may include other parameters. Those skilled in the art can add and set according to actual use requirements. The embodiments of the present disclosure do not limit actual composition contents of the configuration.

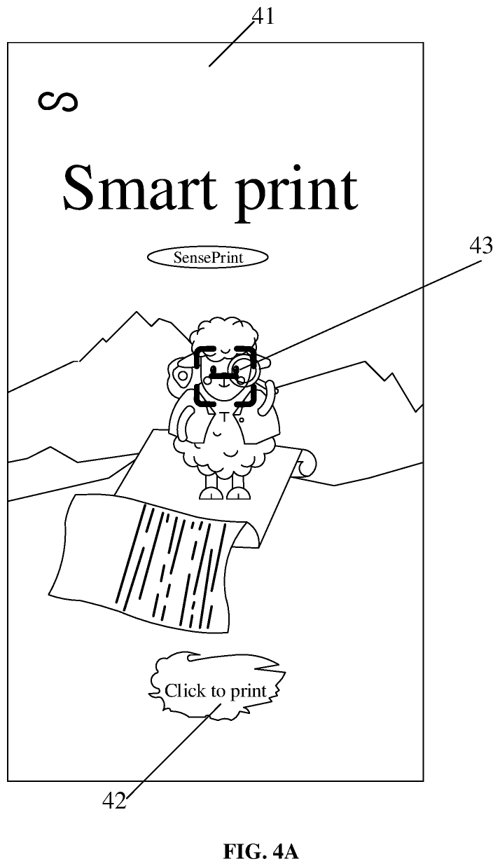

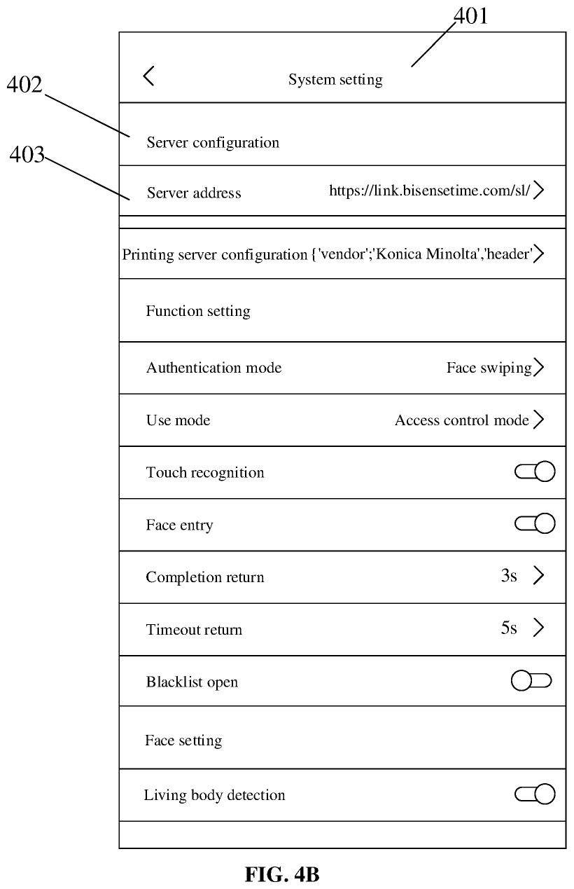

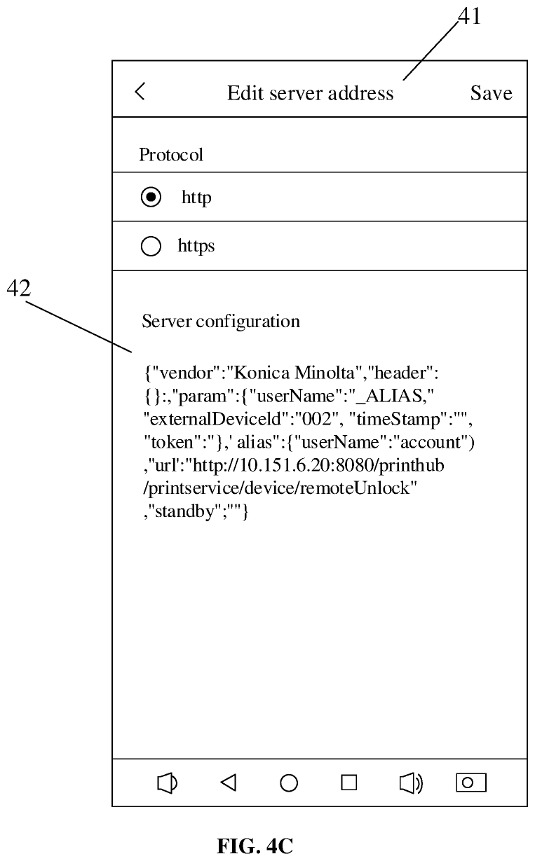

FIG. 4A illustrates a schematic diagram of a standby screen of the face recognition device of the embodiments of the present disclosure. As shown in FIG. 4A, a user click a “click to print” area 42 in a picture 41 to print a required file. For example, after the user clicks the area 42, an area 43 starts to perform face recognition. After a face is recognized successfully, a corresponding file is printed according to a recognition result. Moreover, the standby screen is configurable. “Standby” in the abovementioned typical configuration is a parameter for controlling a screen shown in the picture 41.

FIG. 4B illustrates a schematic diagram of a display interface of a printing application of the embodiments of the present disclosure. As shown in FIG. 4B, an option 402 of “printing server configuration” may be clicked on a setting interface 401 of a face recognition printing application to enter an editing page, so as to modify the configurations for various printing manufacturers. An option 403 of “server address” may also be clicked to enter an editing page, so as to set a server address for a server of each face recognition device. Of course, the display interface of the printing application may also include other options, for example, an authentication mode option, a use mode option, a touch identification option, a face entry option, and a blacklist option. Thus, different printing device manufacturers can be served efficiently by setting and modifying the contents in the options 402 of “printing server configuration”. A plurality of face recognition backgrounds are efficiently compatible by setting and modifying the contents in the options 403 of “server address”.

FIG. 4C illustrates a schematic diagram of a display interface of a printing service configuration of the embodiments of the present disclosure. As shown in FIG. 4C, a user can select whether the transmission protocol is http or https in the display interface 401 of the printing service configuration, and may also edit different transmission parameters for different printing manufacturers in an editing area 42 of “service configuration” below.

Compared with the solution of modifying a program for the background requirements of different printing device manufacturers in the prior art, the solution provided by the embodiments of the present disclosure can reduce the development cost and improve the work efficiency by means of configuration. Thus, a solution that does not need to communicate with different printing manufacturers repeatedly and modify a program to meet the background requirements of different printing devices, but can well serve different printing device manufacturers more efficiently by modifying configurations directly is developed.

Traditional printing is to interact with a printing device in an authentication mode of physical recognition (a work card and a password) to perform the printing of files. The authentication mode of physical recognition is cumbersome. On one hand, file information leakage is easily caused by taking a printed file by mistake; and on the other hand, after the printed file is taken away, a person who needs the printed file needs to print again because the printed file is not gotten, which will also cause unnecessary paper waste. The present utility model provides a printer bracket for a biometric feature-based printing mode.

When a biometric feature-based printing mode is implemented, the biometric feature recognition device often needs to be fixed somewhere, so a printer bracket for fixing the biometric feature recognition device, for example, fixing the biometric feature recognition device to a public area, is needed. Generally, the biometric feature recognition device and a printing device are placed together, and the biometric feature recognition device may be fixed to the printing device or a desk or a wall body next to the printing device.

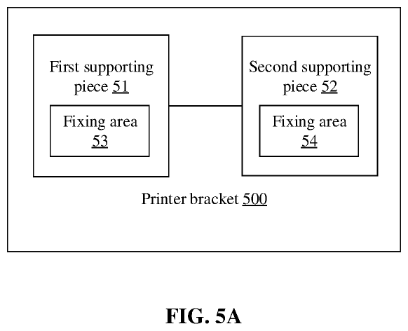

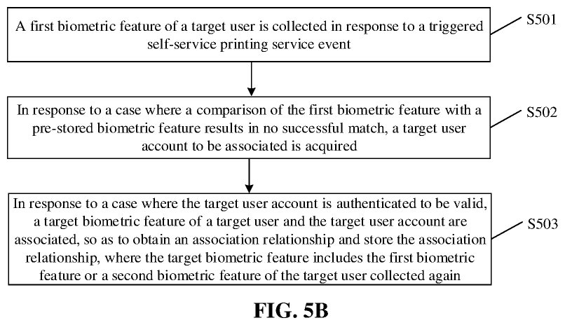

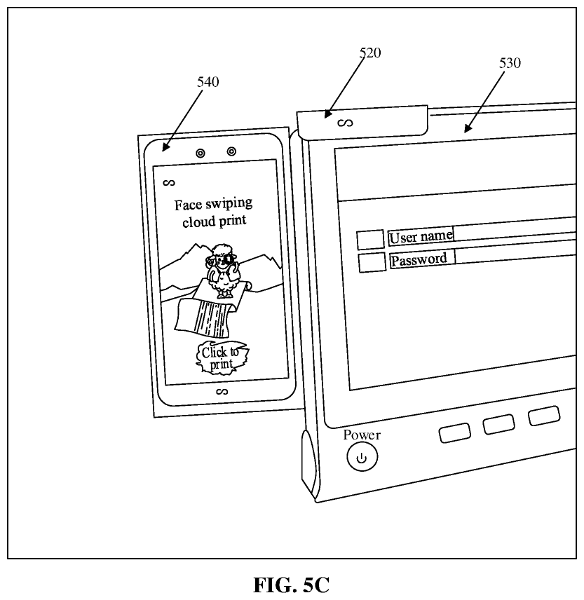

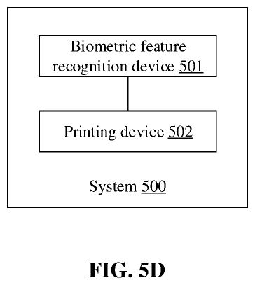

The embodiments of the present disclosure provide a printer bracket. FIG. 5A illustrates a structural schematic diagram of the printer bracket provided by the embodiments of the present disclosure. As shown in FIG. 5A, the printer bracket 500 includes: a first supporting piece 51 and a second supporting piece 52 connected to the first supporting piece 51.

A fixing area is formed in each of the first supporting piece 51 and the second supporting piece 52.

The fixing area 53 of the first supporting piece 51 is arranged for fixing a first electronic device to the first supporting piece 51.

The fixing area 54 of the second supporting piece 52 is arranged for fixing the printer bracket 500 to a supporting surface.

In some embodiments, the first electronic device is at least in communication connection with a printing device or a background of the printing device. The first electronic device is at least configured to collect a biometric feature of a target user. In a case where the biometric feature of the target user is authenticated successfully, the printing device prints the file to be printed of the target user.

In some embodiments, at least one fixing area may be formed in the first supporting piece, and at least one fixing area may also be formed in the second supporting piece.

In some embodiments, the fixing area of the first supporting piece may be all or part area of the first supporting piece, and/or, the fixing area of the second supporting piece may be all or part area of the second supporting piece, which is not limited herein.

In some embodiments, the first supporting piece may fix part or all positions of the first electronic device. The second supporting piece may fix the printer bracket to any side or any part of the supporting surface. The supporting surface may be a surface of the electronic device, or a surface of a non-electronic device, such as a desktop, or a wall body.

The printer bracket in the embodiments of the present disclosure includes the first supporting piece and the second supporting piece. On one hand, the first electronic device is fixed to the first supporting piece by the fixing area of the first supporting piece, herein the first electronic device is at least in communication connection with the printing device or the background of the printing device; and on the other hand, the printer bracket is fixed to the supporting surface by the fixing area of the second supporting piece. Thus, the first electronic device can be fixed to the supporting surface through the printer bracket. When a user uses the first electronic device to recognize a biometric feature such as face information online to print a file, stable supporting can be provided for the first electronic device, so that the user experience is improved.

In some embodiments, the supporting surface is one of the following: a wall surface, a desktop, a second electronic device, or a panel of the second electronic device. The first electronic device is a biometric feature recognition device. The second electronic device is a printing device. At least one of an electrical connection and a communication connection is provided between the printing device and the biometric feature recognition device. The panel of the second electronic device is one of the following: a display panel of the second electronic device, a cover plate of the second electronic device, or a bottom plate of the second electronic device.

Thus, the biometric feature recognition device can be fixed to the positions, such as the wall surface, the desktop, the second electronic device, the display panel of the second electronic device, the cover plate of the second electronic device, and the bottom plate of the second electronic device, which improves the convenience of using the electronic device on any supporting surface.

In some embodiments, the first supporting piece is a first supporting plate, the second supporting piece is a second supporting plate, and the supporting surface is the panel of the second electronic device. The second supporting plate is detachably connected to a side of the first supporting plate, so that the first electronic device can be located on any side of the second electronic device side by side.

Thus, the printer bracket can be mounted on any side of the second electronic device, which facilitates the adjustment of a mounting position of a user when one side of the electronic device cannot be mounted. The printer bracket is mounted on the other side that facilitates the use of the user, so that the use experience of the user is improved.

In some embodiments, a protective surface is also arranged on a surface, in contact with the first electronic device, of the first supporting piece, and/or, on a surface, in contact with the supporting surface, of the second supporting piece.

Thus, when the first supporting piece and the second supporting piece are respectively mounted in contact with the first electronic device and the second electronic device, it is possible to prevent a surface of the second supporting surface and a shell of the first electronic device from being damaged. Thus, the second supporting surface and the first electronic device are protected, and the service life of the device is prolonged.

In some embodiments, the fixing area is implemented in at least one of the following modes: the fixing area is made of a magnetic material; a fixing piece is arranged on the fixing area; the fixing piece uses at least one of the following: a magnetic suction piece, a fastener, a clamping piece, a hanging hook, a threaded connecting piece, and an adhesive piece.

Thus, the electronic device can be fixed to the first supporting plate and the second supporting plate can be fixed to the supporting surface through the magnetic material, the adhesive piece, etc., so that the stability of mounting the printer bracket is improved.

In some embodiments, the first supporting piece is rotatably connected to the second supporting piece.

Thus, the first supporting piece can be adjusted by rotating, so that a biometric feature recognition device on the first supporting piece can adapt to different angles of a face, thereby improving the range and the accuracy of identifying the face by the biometric feature recognition device.

In some embodiments, the first supporting piece is rotatably connected to the second supporting piece, which includes: the first supporting piece and the second supporting piece are rotatably connected in any direction through a ball embedded bearing; or the first supporting piece is connected to the second supporting piece through a rotating shaft, herein an extension direction of the rotating shaft is perpendicular to an intersection line of the contact between the first supporting piece and the second supporting piece.

Thus, any included angle can be formed between the first supporting piece and the second supporting piece by adjusting the connection between the first supporting piece and the second supporting piece through the ball embedded bearing, which meets the requirements of multi-directional multi-angle use of a user.

In some embodiments, at least one limiting piece is further arranged on the first supporting piece, and the limiting piece is arranged for preventing the first electronic device from sliding off.

Thus, the first electronic device can be firmly mounted on the first supporting piece, which prevents the first electronic device from sliding off to cause device damage, and prolongs the service life of the first electronic device.

In some embodiments, the first supporting piece is a rectangular plate, and is provided with at least one hollow area.

Thus, the weight of the first supporting piece can be reduced, so as to reduce the weight of the printing device. Moreover, the hollow area can facilitate removing the device by the user by pressing the device in the hollow area, and facilitates the use of the user. In addition, the hollow area can also facilitate better heat dissipation of the first electronic device, so as to avoid downtime of the device caused by overheating, improve the use experience of a user, improve the use efficiency of the user, and prolong the service life of the first electronic device.

In some embodiments, at least one adjustment piece is also arranged on the second supporting piece, and the adjustment piece is arranged to adjust the fastening degree between the second supporting piece and the supporting surface.

Thus, different thickness of the supporting surface can be adapted by adjusting the adjustment piece. When the supporting surface is the panel of the printing device, the adjustment piece on the printer bracket can be adjusted according to different thickness of the panel of the printing device, so as to adjust the fastening degree between the second supporting piece and the panel of the printing device. Particularly, when the panel of the printing device is a display panel, the printer bracket is suitable for the printing devices with the display panels of different thickness by adjusting the adjustment piece, so that the problem that it is difficult to design a universal printer bracket can be solved.

In another aspect, the embodiments of the present disclosure provide a biometric feature recognition device. The biometric feature recognition device is fixed to the supporting surface by using the abovementioned printer bracket.

In yet another aspect, the embodiments of the present disclosure provide a printing device. The biometric feature recognition device is fixed to the printing device by using the abovementioned printer bracket.

Thus, a biometric feature is recognized by the biometric feature recognition device. In a case where a biometric feature is authenticated successfully, the printing of a file to be printed is performed by matching with the printing device. Therefore, the embodiments of the present disclosure provide a biometric feature-based printing mode.

Traditional printing is to interact with a printing device in an authentication mode of physical recognition (a work card and a password) to perform the printing of files. The authentication mode of physical recognition is cumbersome. On one hand, file information leakage is easily caused by taking a printed file by mistake; and on the other hand, after the printed file is taken away, a person who needs the printed file needs to print again because the printed file is not gotten, which will also cause unnecessary paper waste. A common face swiping and printing device brings a very large workload to the operation of a system administrator. In a case of personnel information addition/change, a user needs to send his photo to the system administrator. If the photo does not meet an recognition standard, a process is repeated and lengthy.

FIG. 5B illustrates an implementation flowchart of a self-service printing method provided by the embodiments of the present disclosure. As shown in FIG. 5B, the method includes the following operations.

At S501, a first biometric feature of a target user is collected in response to a triggered self-service printing service event.

In an implementation process, the biometric feature includes at least one of the following: face information, fingerprint information, voiceprint information, iris information, and finger vein information.

The face information may be regarded as a biometric feature. The biometric feature may also include fingerprint information, voiceprint information, iris information, finger vein information, etc. In other words, a face recognition-based printing mode can be understood as a biometric feature-based printing mode. On this basis, a face recognition device may be understood as an electronic device for performing biometric feature recognition (called a biometric feature recognition device for short). In other words, the biometric feature recognition device may include a face recognition device, a fingerprint recognition device, a voiceprint recognition device, an iris recognition device, a finger vein recognition device, etc. Considering the factors such as easiness in installation, the biometric feature recognition device generally adopts a portable mobile electronic device.

In some embodiments, taking the collected biometric feature being face information as an example, a binocular camera may be arranged on the biometric feature recognition device connected to the printing device.

In some embodiments, the biometric feature recognition device has the capacity of collecting and comparing fingerprint information, voiceprint information, iris information, and finger vein information.

At S502, in response to a case where a comparison of the first biometric feature with a pre-stored biometric feature results in no successful match, a target user account to be associated is acquired.

In some embodiments, the pre-stored biometric feature may be acquired from a biometric feature set stored in the biometric feature recognition device, or may also be acquired from a biometric feature set stored in a background of the biometric feature recognition device. The biometric feature set stores association relationships between at least two pairs of biometric features and user accounts.

In an implementation process, in response to a case where the comparison of the first biometric feature with the pre-stored biometric feature results in no successful match, that is, the first biometric feature is not stored in the biometric feature set, so the first biometric feature needs to be matched with the user account that needs to be printed for storing. A target user account to be associated needs to be acquired to match a corresponding user account.

In some embodiments, a user can manually output his account number on a display screen of the biometric feature recognition device, so that the biometric feature recognition device acquires the target user account to be associated.

In some other embodiments, the biometric feature recognition device may acquire the target user account to be associated by identifying the information of a user identity card.

At S503, in response to a case where the target user account is authenticated to be valid, a target biometric feature of a target user and the target user account are associated, so as to obtain an association relationship and store the association relationship, herein the target biometric feature includes the first biometric feature or a second biometric feature of the target user collected again.

In an implementation process, two methods for acquiring the biometric feature are provided, including method 1 and method 2.

Method 1, in a case where the first biometric feature (collected by the biometric feature recognition device for the first time) meets an association requirement (that is, meets a biometric feature required for associating the target user account, which may be understood as a second preset condition hereafter), the first biometric feature collected for the first time may be directly taken as a target biometric feature of the target user, and the first biometric feature and the target user account are associated to obtain an association relationship and store the association relationship.

Method 2, in a case where the first biometric feature does not meet an association requirement, for example, the integrity and/or clarity of the first biometric feature does not meet the requirement, a second biometric feature meeting the requirement needs to be collected for a second time. During collecting, the biometric feature recognition device can give a user some collection adjustment methods, so that the acquired second biometric feature meets the association requirement. In a case where the second biometric feature obtained by collecting for the second time meets the association requirement, the second biometric feature is taken as the target biometric feature, and the second biometric feature and the target user account are associated, so as to obtain an association relationship and store the association relationship.

In some embodiments, after the storage of the association relationship is performed, if the user still needs to print a file, the biometric feature of the target user needs to be collected for a third time to compare with a biometric feature preset in a stored biometric feature set, and printing is performed in a case where the comparison results in a successful match. Here, both the integrity and the clarity of the third biometric feature obtained by collecting for the third time may be lower than those of the target biometric feature.

In the embodiments of the present disclosure, a user may enter the biometric feature at the biometric feature recognition device when using the printing device for the first time so as to associate the biometric feature and the user account, and store the association relationship. Thus, the biometric feature recognition device enters the biometric feature in a self-service mode without the intervention of an administrator, and integrally enters the biometric features in a self-service mode and binds with the user accounts, which is convenient and quick. Thus, the problems that the common face swiping and printing device bring a very large workload to the operation of the system administrator, the user needs to send his photo to the system administrator in a case of personnel information addition/change, and if the photo does not meet an identification standard, the process is repeated and lengthy are solved.

In a case where a user needs to print a file, the biometric feature of the user may be used for user recognition, and completing the printing of the file to be printed under the user account associated with the biometric feature of the user, so as to ensure that the user can be subjected to identity recognition within a range of a target printing device and can wait for a printed file to be transmitted on the spot, which prevents the printed file from being taken late or being taken by mistake, and prevents possible paper waste and security information leakage, thereby establishing a safe, efficient, and economical biometric feature recognition printing solution.

In some embodiments, the biometric feature includes at least one of the following: face information, fingerprint information, voiceprint information, iris information, and finger vein information.

Thus, self-service printing registration may be realized by using a plurality of different biometric features.

In some embodiments, biometric feature unbound information is output in response to a case where the comparison of the first biometric feature with the pre-stored biometric feature results in no successful match, herein the biometric feature unbound information is used to prompt a target user to perform registration of a self-service printing service by binding the user account of the target user; and/or, a biometric feature binding success information is output in response to a case where the target user account is authenticated to be valid, herein the biometric feature binding success information is used to prompt the user to perform the registration of the self-service printing service.

Thus, the user is prompted in the modes of text, images, or voice, which can help the user to perform self-service printing registration smoothly, and bring good product use experience to the user.

In some embodiments, the operation that a first biometric feature of a target user is collected in response to triggering a self-service printing service event presented on a standby screen includes: the standby screen is presented; the first biometric feature of the target user is collected in response to triggering the self-service printing service event on the standby screen; and after the biometric feature binding success information is output, the method further includes: the standby screen is returned.

Thus, after the collection processing o the biometric feature recognition device is performed, the standby screen may be returned to achieve a power saving effect.

In some embodiments, the operation that the biometric feature unbound information is output in response to a case where the comparison of the first biometric feature with the pre-stored biometric feature results in no successful match includes: the biometric feature unbound information is output in response to a case where the first biometric feature satisfies a first preset condition and the comparison of the first biometric feature with the pre-stored biometric feature results in no successful match; correspondingly, the operation that a biometric feature binding success information is output in response to a case where the target user account is authenticated to be valid includes: the biometric feature binding success information is output in response to a case where the first biometric feature satisfies a second preset condition and the target user account is authenticated to be valid; and the requirement of the second preset condition is higher than that of the first preset condition.

Thus, the biometric feature recognition device can recognize the biometric feature of a user quickly, efficiently, and correctly by determining that the collected biometric feature meets a binding requirement of the user account during self-service printing.

In some embodiments, the operation that the biometric feature binding success information is output in response to a case where the target user account is authenticated to be valid includes: a second biometric feature of the target user is collected in response to that the first biometric feature does not satisfies a second preset condition; and the biometric feature binding success information is output in response to a case where the second biometric feature satisfies the second preset condition, and the target user account is authenticated to be valid.

Thus, the biometric feature recognition device can collect to acquire a biometric feature with better clarity and integrity to bind a user account for a plurality of times by determining whether the collected biometric feature meets a binding requirement of the user account, so that the biometric feature of the user can be recognized quickly, efficiently, and correctly during self-service printing.

In some embodiments, in response to a case where the target user account is authenticated to be valid, or in response to a case where the comparison of the first biometric feature with the pre-stored biometric feature results in a successful match, a printing request carrying the target user account is sent to a printing device or a background of the printing device, herein the printing request is used to request the printing device to print a file to be printed corresponding to the target user account.

Thus, in some embodiments, in response to a case where the target user account is authenticated to be valid, or, in response to a case where the comparison of the first biometric feature with the pre-stored biometric feature results in a successful match, printing prompt information is output, herein the print prompt information is at least used to prompt a user to collect a printed file on the printing device and/or prompt a printing state of the file to be printed. The printing prompt information at least includes a target user account associated with the first biometric feature, and/or a nickname associated with the target user account.

Thus, the printing prompt information used to prompt the user to collect the printed file on the printing device and/or prompt the printing state of the file to be printed is output, which can prompt the user of the state of the file that needs to be printed, and prompt the user to collect the printed file, so as to prevent the printed file from being taken late or being taken by mistake, and prevent possible paper waste and security information leakage, thereby establishing a safe, efficient, and economical biometric feature recognition printing solution. The printing prompt information at least includes a target user account associated with the first biometric feature, and/or the nickname associated with the target user account, which can give the user a good printing experience.

In some embodiments, an address of a background of the biometric feature recognition device is acquired from background configuration information; a biometric feature recognition request carrying the first biometric feature is sent to the background of the biometric feature recognition device in a unified packaging format based on the address of the background of the biometric feature recognition device, herein the biometric feature recognition request is used to: compare the first biometric feature with a pre-stored biometric feature; and a biometric feature recognition response sent by the background of the biometric feature recognition device, herein the biometric feature recognition response includes a result that the comparison results in a successful match or a result that the comparison results in no successful match.

Thus, the biometric feature recognition request carrying the first biometric feature is sent to the background of the biometric feature recognition device in a unified packaging format, which can be compatible with the backgrounds of a variety of biometric feature recognition devices with different models to perform biometric feature recognition.

In some embodiments, before the first biometric feature of the target user is collected, the method further includes: a background configuration interface is presented in response to an acquired background configuration event, herein the background configuration interface is at least configured to acquire an address of a background of a biometric feature recognition device and an address of a background for user account authentication; a user configuration event is received on the background configuration interface; and background configuration information is acquired based on the user configuration event, herein the background configuration information includes the address of the background of the biometric feature recognition device and the address of the background for user account authentication.

Thus, the biometric feature recognition device provides a configuration interface to perform the configurations of the address of the background of the biometric feature recognition device, the address of the background for user account authentication, and a background of a printing server. The background for user account authentication has high safety in authenticating the user account; the recognition of the biometric feature is performed at the background, which is suitable for a large number of user groups, for example, thousands or even tens of thousands of users; and the configuration of the background of the printing device can make the biometric feature recognition device adapt to the printing devices of different models.

In some embodiments, in a case where the biometric feature is face information, the operation that the first biometric feature of the target user is collected includes that a first face image of the target user is collected; and the operation that the target user account to be associated includes: a card image obtained based on collecting a user identity card is recognized to obtain card information, herein the card information at least includes a target user account and a second face image. The method further includes: the target user account is authenticated according to a preset authentication rule, so as to obtain an account authentication result; the second face image is compared with the first face image to obtain a face comparison result; and in response to a case where the account authentication result is that the authentication is successful and the face comparison result is that the comparison results in a successful match, it is determined that the target user account is authenticated to be valid.

Thus, when the user performs self-service printing registration, a user account does not need to be input manually, and the authentication of an identity can be performed by only recognizing an identity card by using the biometric feature recognition device. In the case where the identity is authenticated successfully, the target face image (the first face image or the second face image meeting requirements) and the target user account are associated to achieve an effect of self-service printing registration safely and efficiently.

In some embodiments, in response to the detection of the user identity card, the card image obtained based on collecting the user identity card is recognized to obtain card information; the card information at least includes a target user account; the printing request carrying the target user account is sent to a printing device or a background of the printing device, herein the printing request is used to request the printing device to print a file to be printed corresponding to the target user account.

Thus, in a case where the target user account is not associated with the biometric feature for identification, valid printing may be performed by recognizing the user identity card.

In some embodiments, in the case where the biometric feature is face information, the first biometric feature includes an near-infrared image and a color image of a face, and the method further includes: living body authentication is performed on a target user based on the near-infrared image; and in response to a case where a living body is authenticated successfully, comparison is performed based on the color image and the pre-stored face image.

Thus, the binocular camera is arranged to perform living body detection and photograph the color image, which can effectively ensure that it is the user who performs self-service printing.

In some embodiments, in response to a case where the living body is authenticated successfully, attitude adjustment prompt information is output, herein the attitude adjustment prompt information is used to prompt a user to adjust an attitude to realize re-collection; image collection is performed on the user after attitude adjustment, so as to obtain an updated color image; and comparison is performed based on the updated color image and the pre-stored face information.

Thus, in a case where the living body is authenticated successfully, the user needs to adjust the attitude, so as to collect a color image satisfying a second preset condition. Correct and efficient collection of the color image can be performed through prompt.

In some embodiments, a self-service printing apparatus is provided, including: a collection module, configured to collect a first biometric feature of a target user in response to a triggered self-service printing service event; an acquisition module, configured to acquire a target user account to be associated in response to a case where the comparison of the first biometric feature with the pre-stored biometric feature results in no successful match; an association module, configured to associate the target biometric feature of the target user with the target user account in response to a case where the target user account is authenticated to be valid, so as to obtain an association relationship and store the association relationship, herein the target biometric feature includes the first biometric feature or a second biometric feature of the target user collected again.

FIG. 5C illustrates a schematic diagram of the connection between a biometric feature recognition device and a printing device provided by the embodiments of the present disclosure. As shown in FIG. 5C, a printer bracket 520 may be mounted on a left side of a display panel of a printing device 530. A biometric feature recognition device 540 is fixed to a first supporting plate of the printer bracket.

Based on the previously described embodiment, the embodiments of the present disclosure provide a compatible system for a self-service printing background. FIG. 5D illustrates a schematic structural diagram of compositions of a compatible system for the self-service printing background of the embodiments of the present disclosure. As shown in FIG. 5D, the system 500 includes: a biometric feature recognition device 501 and a printing device 502.

The biometric feature recognition device 501 is configured to: present a background configuration interface in response to an acquired background configuration event, herein the background configuration interface is at least configured to configure interaction parameters between the biometric feature recognition device and a background of the biometric feature recognition device and between the biometric feature recognition device and a printing device; receive a user configuration event on the background configuration interface; acquire background configuration information of the printing device and an address of the background of the biometric feature recognition device based on the user configuration event, herein the background configuration information of the printing device includes printing parameters of the printing device and an address of the printing device; and perform the configurations between the biometric feature recognition device and the background of the biometric feature recognition device and between the biometric feature recognition device and the printing device based on the background configuration information of the printing device and the address of the background of the biometric feature recognition device.

The printing device 502 is configured to: perform a self-service printing service in a case where the configurations between the biometric feature recognition device and the background of the biometric feature recognition device and between the biometric feature recognition device and the printing device are completed.

In some embodiments, the biometric feature recognition device 501 is configured to: send, based on an address of a background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

In some embodiments, the biometric feature recognition device 501 is further configured to: perform a first test on a connection between the biometric feature recognition device and the background of the biometric feature recognition device based on the address of the background of the biometric feature recognition device; perform a second test on a connection between the biometric feature recognition device and the printing device based on the background configuration information of the printing device; and output a background configuration completion message in response to the success of both the first test and the second test.

In some embodiments, the biometric feature recognition device 501 may be fixed to the printing device 502 by using a printer bracket.

It is to be pointed out here that: the descriptions about the abovementioned system embodiments are similar to the descriptions about the abovementioned method embodiments, which have similar beneficial effects with the method embodiments. Technical details undisclosed in the system embodiments of the present disclosure may be understood with reference to the descriptions about the method embodiments of the present disclosure.

Based on the previously described embodiments, the embodiments of the present disclosure provide a compatible apparatus for the self-service printing background. Each unit included in the apparatus, each module included in each unit and each component included in each module may be implemented by a processor in a biometric feature recognition device and, of course, may also be implemented by a specific logic circuit. In an implementation process, the processor may be a Central Processing Unit (CPU), a Microprocessor Unit (MPU), a Digital Signal Processor (DSP), a Field Programmable Gate Array (FPGA), or the like.

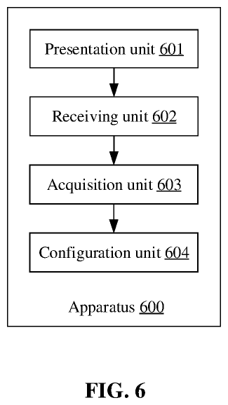

FIG. 6 illustrates a schematic structural diagram of compositions of a compatible apparatus for the self-service printing background of the embodiments of the present disclosure. As shown in FIG. 6, the apparatus 600 includes: a presentation unit 601, a receiving unit 602, an acquisition unit 603, and a configuration unit 604.

The presentation unit 601 is configured to present a background configuration interface in response to an acquired background configuration event, herein the background configuration interface is at least configured to configure interaction parameters between the biometric feature recognition device and the background of the biometric feature recognition device and between the biometric feature recognition device and the printing device.

The receiving unit 602 is configured to receive a user configuration event on the background configuration interface.

The acquisition unit 603 is configured to acquire background configuration information of the printing device and an address of the background of the biometric feature recognition device based on the user configuration event, herein the background configuration information of the printing device includes printing parameters of the printing device and an address of the printing device.

The configuration unit 604 is configured to perform configurations between the biometric feature recognition device and the background of the biometric feature recognition device and between the biometric feature recognition device and the printing device based on the background configuration information of the printing device and the address of the background of the biometric feature recognition device.

In some embodiments, the biometric feature recognition device is configured to: send, based on an address of a background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

In some embodiments, the apparatus may further include a first test unit, a second test unit, and an output unit.

The first test unit is configured to perform a first test on a connection between the biometric feature recognition device and the background of the biometric feature recognition device based on the address of the background of the biometric feature recognition device.

The second test unit is configured to perform a second test on a connection between the biometric feature recognition device and the printing device based on the background configuration information of the printing device.

The output unit is configured to output a background configuration completion message in response to a case where both the first test and the second test are successful.

In some embodiments, the apparatus further includes: an event acquisition unit, configured to acquire a background configuration event. The event acquisition unit includes: a first detection unit, configured to detect an invalid address of the printing device; a second detection unit, configured to detect an invalid address of the background of the biometric feature recognition device; and a third detection module, configured to detect a key instruction satisfying a preset condition.

In some embodiments, the background configuration interface is further configured to configure interaction parameters between the biometric feature recognition device and a background for user account authentication, herein the background configuration information further includes an address of the background for user account authentication; and the biometric feature recognition device is configured to send, based on the address of the background for user account authentication, a collected user account to the background for user account authentication, so as to obtain an account authentication result.

The biometric feature recognition device is further configured to: in response to a case where the account authentication result is that the authentication is successful, associate a second face image to be entered with the user account to obtain an association relationship, and send the association relationship to the background of the biometric feature recognition device for storing; or, the biometric feature recognition device is further configured to: in response to a case where the account authentication result is that the authentication is successful, send the second face image to be entered and the user account to the background of the biometric feature recognition device for associating the second face image with the user account to obtain the association relationship.

In some embodiments, the acquisition unit 603 includes: a first acquisition module, configured to acquire user configuration parameters corresponding to the user configuration event based on the user configuration event, herein the user configuration parameters include an identifier of the background of the biometric feature recognition device; and a first matching module, configured to determine one or more addresses matching an address of the background of the biometric feature recognition device from an address list based on the identifier of the background of the biometric feature recognition device.

The apparatus further includes: a presentation unit, configured to present an address of the background of the biometric feature recognition device, so that a user modifies or confirms the address of the background of the biometric feature recognition device.

In some embodiments, the identifier of the background of the biometric feature recognition device includes a type of the background of the biometric feature recognition device and a user keyword. The first matching module includes: an address determination component, a first response component, a second response component, and a third response component. The address determination component is configured to determine at least one candidate background address based on the type of the background of the biometric feature recognition device and the user keyword.

The first response component is configured to determine the only one address as the address of the background of the biometric feature recognition device in response to a case where the at least one candidate background address is one address.

The second response component is configured to present the more than two addresses in the form of list in response to a case where the at least one candidate background address is more than two addresses.

The third response component is configured to acquire an address of the background of the biometric feature recognition device in response to a triggering event on a selection list.

In some embodiments, the acquisition unit 603 includes: a second acquisition module, configured to acquire, based on a user configuration event, user configuration parameters corresponding to the user configuration event, herein the user configuration parameters include a model of the printing device; a second matching module, configured to determine a configuration template matching a target configuration template from a preset template library based on the model of the printing device, herein the target configuration template includes printing parameters of the printing device enumerated by way of example, format requirements of the printing parameters, and modes of viewing the printing parameters; and an information acquisition module, configured to acquire the background configuration information of the printing device based on an input event of the user after the target configuration template is presented.

In some embodiments, the printing parameters include mandatory option parameters and default configuration item parameters. The acquisition unit 603 further includes: a parameter determination unit, configured to determine the default configuration item parameters based on the model of the printing device; and a filling module, configured to fill the default configuration item parameters into the target configuration template, herein the target configuration template includes the mandatory option parameters enumerated by way of example, format requirements of the mandatory option parameters, and modes of viewing the mandatory option parameters.

In some embodiments, the default configuration item parameters at least include one of the following: a transmission protocol, a timestamp, a signature, and a credential. The mandatory option parameters include a user identifier.

The above descriptions about the apparatus embodiments are similar to descriptions about the method embodiments and beneficial effects similar to those of the method embodiments are achieved. Technical details undisclosed in the apparatus embodiments of the present disclosure may be understood with reference to the descriptions about the method embodiments of the present disclosure.

It is to be noted that, in the embodiments of the present disclosure, when implemented in form of a software functional module and sold or used as an independent product, the abovementioned compatible method for the self-service printing background or the self-service printing method may also be stored in a computer readable storage medium. Based on such an understanding, the technical solutions of the embodiments of the present disclosure substantially or parts making contributions to the conventional art may be embodied in form of a software product. The computer software product is stored in a storage medium, including a plurality of instructions configured to enable an electronic device (which may be a personal computer, a server, etc.) to execute all or part of the method in each embodiment of the present disclosure. The previously described storage medium includes: various media capable of storing program codes, such as a USB flash drive, a mobile hard disc, a Read Only Memory (ROM), a magnetic disc, or a compact disc. Therefore, the embodiments of the present disclosure are not limited to any specific hardware and software combination.

Correspondingly, the embodiments of the present disclosure provide a biometric feature recognition device, which includes a memory and a processor. The memory stores a computer program capable of running in the processor. The processor executes the program to implement the operations in the compatible method for the self-service printing background or the self-service printing method provided in the abovementioned embodiments.

Correspondingly, the embodiments of the present disclosure provide a readable storage medium having a computer program stored thereon. The computer program is executed by a processor to implement the operations in the compatible method for the self-service printing background or the self-service printing method.

It is to be pointed out that the above descriptions about the storage medium and device embodiments are similar to the descriptions about the method embodiment and beneficial effects similar to those of the method embodiment are achieved. Technical details undisclosed in the storage medium and device embodiments of the present disclosure are understood with reference to the descriptions about the method embodiment of the present disclosure.

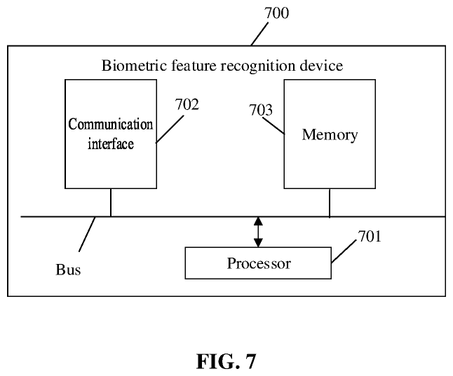

It is to be noted that FIG. 7 is a schematic diagram of a hardware entity of a biometric feature recognition device of the embodiments of the present disclosure. As shown in FIG. 7, the hardware entity of the biometric feature recognition device 700 includes a processor 701, a communication interface 702, and a memory 703.

The processor 701 usually controls overall operations of the biometric feature recognition device 700.

The communication interface 702 may enable the biometric feature recognition device 700 to communicate with another electronic device or a server through a network.

The memory 703 is configured to store an instruction and application executable for the processor 701, may also cache data (for example, image data, video data, voice communication data, and video communication data) to be processed or having been processed by the processor 701 and each module in the biometric feature recognition device 700, and may be implemented by a flash or a Random Access Memory (RAM).

In several embodiments provided by the present disclosure, it is to be understood that the disclosed device and method may be implemented in other modes. The device embodiment described above is only schematic, and for example, division of the units is only logic function division, and other division manners may be adopted during practical implementation. For example, a plurality of units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The abovementioned units described as separate parts may be or may not be physically separated, and the parts shown as units may be or may not be physical elements, which may be located in one place or distributed to a plurality of network elements. Part or all of the units may be selected to achieve the objectives of the solutions of the embodiments according to practical requirements.

In addition, each function unit in each embodiment of the present disclosure may be integrated into a processing module, each unit may also serve as an independent unit, or two or more than two units may also be integrated into a unit. The integrated unit may be implemented in a hardware form and may also be implemented in form of hardware and software function unit. Those of ordinary skill in the art can understand that: all or part of the operations of the abovementioned method embodiments may be performed through hardware associated with program instructions. The previously described program may be stored in a computer readable storage medium. The operations including the abovementioned method embodiments are executed when the program is executed. The previously described storage medium includes various media capable of storing program codes, such as a mobile storage device, a ROM, a RAM, a magnetic disk, or a compact disc.

The methods disclosed in some method embodiments provided in the present disclosure may be freely combined without conflicts to obtain new method embodiments.

The characteristics disclosed in several product embodiments provided in the present disclosure may be freely combined without conflicts to obtain new product embodiments.

The characteristics disclosed in several method or device embodiments provided in the disclosure may be freely combined without conflicts to obtain new method embodiments or device embodiments.

The foregoing descriptions are merely specific implementations of The present disclosure, but are not intended to limit the protection scope of The present disclosure. Any variation or replacement readily figured out by a person skilled in the art within the technical scope disclosed in The present disclosure shall fall within the protection scope of The present disclosure. Therefore, the scope of protection of the present disclosure shall be subject to the scope of protection of the claims.

### INDUSTRIAL APPLICABILITY

The embodiments of the present disclosure provide a compatible method and apparatus for a self-service printing background, a device, a storage medium, and a system. The method includes: a background configuration interface is presented in response to an acquired background configuration event, herein the background configuration interface is at least configured to configure interaction parameters between the biometric feature recognition device and a background of the biometric feature recognition device and between the biometric feature recognition device and a printing device; a user configuration event is received on the background configuration interface; background configuration information of the printing device and an address of the background of the biometric feature recognition device are acquired based on the user configuration event, herein the background configuration information of the printing device includes printing parameters of the printing device and an address of the printing device; and the configurations between the biometric feature recognition device and the background of the biometric feature recognition device and between the biometric feature recognition device and the printing device are performed based on the background configuration information of the printing device and the address of the background of the biometric feature recognition device. According to the compatible method for the self-service printing background provided by the embodiments of the present disclosure, the requirements of the backgrounds of different biometric feature recognition devices and different printing devices can be compatible by means of configuration, so as to reduce the development cost and improve the work efficiency.

1. A compatible method for a self-service printing background, applied to a biometric feature recognition device, the method comprising:
presenting a background configuration interface in response to an acquired background configuration event, wherein the background configuration interface is at least configured to configure interaction parameters between the biometric feature recognition device and a background of the biometric feature recognition device and between the biometric feature recognition device and a printing device;
receiving a user configuration event on the background configuration interface;
acquiring background configuration information of the printing device and an address of the background of the biometric feature recognition device based on the user configuration event, wherein the background configuration information of the printing device comprises printing parameters of the printing device and an address of the printing device; and
performing configurations between the biometric feature recognition device and the background of the biometric feature recognition device and between the biometric feature recognition device and the printing device based on the background configuration information of the printing device and the address of the background of the biometric feature recognition device.

2. The method of claim 1, wherein the biometric feature recognition device is configured to: send, based on the address of the background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

3. The method of claim 1, further comprising:
performing a first test on a connection between the biometric feature recognition device and the background of the biometric feature recognition device based on the address of the background of the biometric feature recognition device;
performing a second test on a connection between the biometric feature recognition device and the printing device based on the background configuration information of the printing device; and
outputting a background configuration completion message in response to a case where both the first test and the second test are successful.

4. The method of claim 1, further comprising:
acquiring the background configuration event, which comprises at least one of:
detecting an invalid address of the printing device;
detecting an invalid address of the background of the biometric feature recognition device; or
detecting a key instruction satisfying a preset condition.

5. The method of claim 1, wherein the background configuration interface is further configured to configure interaction parameters between the biometric feature recognition device and a background for user account authentication;
the background configuration information further comprises an address of the background for user account authentication;
the biometric feature recognition device is configured to send, based on the address of the background for user account authentication, a collected user account to the background for user account authentication, so as to obtain an account authentication result;
the biometric feature recognition device is configured to: in response to a case where the account authentication result is that the authentication is successful, associate a second face image to be entered with the user account to obtain an association relationship, and send the association relationship to the background of the biometric feature recognition device for storing; or, the biometric feature recognition device is further configured to: in response to a case where the account authentication result is that the authentication is successful, send the second face image to be entered and the user account to the background of the biometric feature recognition device for associating the second face image with the user account to obtain the association relationship.

6. The method of claim 1, wherein acquiring the address of the background of the biometric feature recognition device based on the user configuration event comprises:
acquiring user configuration parameters corresponding to the user configuration event based on the user configuration event, wherein the user configuration parameters comprise an identifier of the background of the biometric feature recognition device;
determining one or more addresses matching an address of the background of the biometric feature recognition device from an address list based on the identifier of the background of the biometric feature recognition device,
the method further comprises:
presenting an address of the background of the biometric feature recognition device, so that a user modifies or confirms the address of the background of the biometric feature recognition device.

7. The method of claim 6, wherein the identifier of the background of the biometric feature recognition device comprises a type of the background of the biometric feature recognition device and a user keyword,
determining the one or more addresses matching the address of the background of the biometric feature recognition device the address from the address list based on the identifier of the background of the biometric feature recognition device comprises:
determining at least one candidate background address based on the type of the background of the biometric feature recognition device and the user keyword;
determining, in response to a case where the at least one candidate background address is one address, the only one address as the address of the background of the biometric feature recognition device;
presenting, in response to a case where the at least one candidate background address is more than two addresses, the more than two addresses in the form of list; and
acquiring the address of the background of the biometric feature recognition device in response to a triggering event on a selection list.

8. The method of claim 1, wherein acquiring the background configuration information of the printing device based on the user configuration event comprises:
acquiring user configuration parameters corresponding to the user configuration event based on the user configuration event, wherein the user configuration parameters comprise a model of the printing device;
determining a configuration template matching a target configuration template from a preset template library based on the model of the printing device, wherein the target configuration template comprises printing parameters of the printing device enumerated by way of example, format requirements of the printing parameters, and modes of viewing the printing parameters; and
after the target configuration template is presented, acquiring the background configuration information of the printing device based on an input event of a user.

9. The method of claim 8, wherein the printing parameters comprise mandatory option parameters and default configuration item parameters;
acquiring the background configuration information of the printing device based on the user configuration event further comprises:
determining the default configuration item parameters based on the model of the printing device; and
filling the default configuration item parameters into the target configuration template,
wherein the target configuration template comprises the mandatory option parameters enumerated by way of example, format requirements of the mandatory option parameters, and modes of viewing the mandatory option parameters.

10. The method of claim 9, wherein the default configuration item parameters at least comprise one of the following: a transmission protocol, a timestamp, a signature, and a credential; or
the mandatory option parameters comprise a user identifier.

11. A compatible apparatus for a self-service printing background, comprising:
a memory storing processor-executable instructions; and
a processor configured to execute the stored processor-executable instructions to perform operations of:
presenting a background configuration interface in response to an acquired background configuration event, wherein the background configuration interface is at least configured to configure interaction parameters between a biometric feature recognition device and a background of the biometric feature recognition device and between the biometric feature recognition device and a printing device;
receiving a user configuration event on the background configuration interface;
acquiring background configuration information of the printing device and an address of the background of the biometric feature recognition device based on the user configuration event, wherein the background configuration information of the printing device comprises printing parameters of the printing device and an address of the printing device; and
performing configurations between the biometric feature recognition device and the background of the biometric feature recognition device and between the biometric feature recognition device and the printing device based on the background configuration information of the printing device and the address of the background of the biometric feature recognition device.

12. The apparatus of claim 11, wherein the biometric feature recognition device is configured to: send, based on the address of the background of the biometric feature recognition device, a collected first face image to be recognized to the background of the biometric feature recognition device, so as to obtain a user account associated with the first face image; generate a printing request based on the printing parameters of the printing device and the user account; and send, based on the address of the printing device, the printing request to the printing device for performing a self-service printing service.

13. The apparatus of claim 11, wherein the processor is configured to execute the stored processor-executable instructions to further perform operations of:
performing a first test on a connection between the biometric feature recognition device and the background of the biometric feature recognition device based on the address of the background of the biometric feature recognition device;
performing a second test on a connection between the biometric feature recognition device and the printing device based on the background configuration information of the printing device; and
outputting a background configuration completion message in response to a case where both the first test and the second test are successful.

14. The apparatus of claim 11, wherein the processor is configured to execute the stored processor-executable instructions to further perform operations of:
acquiring the background configuration event, which comprises at least one of:
detecting an invalid address of the printing device;
detecting an invalid address of the background of the biometric feature recognition device; or
detecting a key instruction satisfying a preset condition.

15. The apparatus of claim 11, wherein the background configuration interface is further configured to configure interaction parameters between the biometric feature recognition device and a background for user account authentication;
the background configuration information further comprises an address of the background for user account authentication;
the biometric feature recognition device is configured to send, based on the address of the background for user account authentication, a collected user account to the background for user account authentication, so as to obtain an account authentication result;
the biometric feature recognition device is configured to: in response to a case where the account authentication result is that the authentication is successful, associate a second face image to be entered with the user account to obtain an association relationship, and send the association relationship to the background of the biometric feature recognition device for storing; or, the biometric feature recognition device is further configured to: in response to a case where the account authentication result is that the authentication is successful, send the second face image to be entered and the user account to the background of the biometric feature recognition device for associating the second face image with the user account to obtain the association relationship.

16. The apparatus of claim 11, wherein acquiring the address of the background of the biometric feature recognition device based on the user configuration event comprises:
acquiring user configuration parameters corresponding to the user configuration event based on the user configuration event, wherein the user configuration parameters comprise an identifier of the background of the biometric feature recognition device;
determining one or more addresses matching an address of the background of the biometric feature recognition device from an address list based on the identifier of the background of the biometric feature recognition device,
the processor is configured to execute the stored processor-executable instructions to further perform an operation of:
presenting an address of the background of the biometric feature recognition device, so that a user modifies or confirms the address of the background of the biometric feature recognition device.

17. The apparatus of claim 16, wherein the identifier of the background of the biometric feature recognition device comprises a type of the background of the biometric feature recognition device and a user keyword,
determining the one or more addresses matching the address of the background of the biometric feature recognition device the address from the address list based on the identifier of the background of the biometric feature recognition device comprises:
determining at least one candidate background address based on the type of the background of the biometric feature recognition device and the user keyword;
determining, in response to a case where the at least one candidate background address is one address, the only one address as the address of the background of the biometric feature recognition device;
presenting, in response to a case where the at least one candidate background address is more than two addresses, the more than two addresses in the form of list; and
acquiring the address of the background of the biometric feature recognition device in response to a triggering event on a selection list.

18. The apparatus of claim 11, wherein acquiring the background configuration information of the printing device based on the user configuration event comprises:
acquiring user configuration parameters corresponding to the user configuration event based on the user configuration event, wherein the user configuration parameters comprise a model of the printing device;
determining a configuration template matching a target configuration template from a preset template library based on the model of the printing device, wherein the target configuration template comprises printing parameters of the printing device enumerated by way of example, format requirements of the printing parameters, and modes of viewing the printing parameters; and
after the target configuration template is presented, acquiring the background configuration information of the printing device based on an input event of a user.

19. The apparatus of claim 18, wherein the printing parameters comprise mandatory option parameters and default configuration item parameters;
acquiring the background configuration information of the printing device based on the user configuration event further comprises:
determining the default configuration item parameters based on the model of the printing device; and
filling the default configuration item parameters into the target configuration template,
wherein the target configuration template comprises the mandatory option parameters enumerated by way of example, format requirements of the mandatory option parameters, and modes of viewing the mandatory option parameters.

20. A non-transitory computer-readable storage medium having stored thereon a computer-executable instructions that, when executed by a processor, cause the processor to implement operations of:
presenting a background configuration interface in response to an acquired background configuration event, wherein the background configuration interface is at least configured to configure interaction parameters between a biometric feature recognition device and a background of the biometric feature recognition device and between the biometric feature recognition device and a printing device;
receiving a user configuration event on the background configuration interface;
acquiring background configuration information of the printing device and an address of the background of the biometric feature recognition device based on the user configuration event, wherein the background configuration information of the printing device comprises printing parameters of the printing device and an address of the printing device; and
performing configurations between the biometric feature recognition device and the background of the biometric feature recognition device and between the biometric feature recognition device and the printing device based on the background configuration information of the printing device and the address of the background of the biometric feature recognition device.
